(19) United States
(12) Patent Application Publication
(10) Pub. No.: US 2005/0288992 A1
(43) Pub. Date: Dec. 29, 2005

(54) System and method for selection of development processes needing corrective action

(75) Inventors: Jerry D. Ackaret, Beaverton, OR (US); Roy G. Inness III, Cary, NC (US)

Correspondence Address: VAN LEEUWEN & VAN LEEUWEN, P.O. BOX 90609, AUSTIN, TX, 78709-0609, US

(73) Assignee: International Business Machines Corporation, Armonk, NY (US)

(21) Appl. No.: 10/878,778

(22) Filed: Jun. 28, 2004

(51) Int. Cl. G06Q 90/00

(52) U.S. Cl. 705/10

(57) ABSTRACT

A system and method for selection of development processes that require corrective action is presented. A process improvement lessons learned procedure classifies and assigns priority rankings to improvable development processes. A process improvement lessons learned procedure includes several stages of list expansions and reductions that consider the probability of poor use of resources, the probability of a process being ineffective, and the probability of a process causing schedule impacts. The probabilities are multiplied together to not only provide a list of continuous improvement possibilities a team addresses, but a continuous improvement priority ranking provides a team with the order in which resources should be applied to each improvable development process.

### BACKGROUND OF THE INVENTION

1. Technical Field

The present invention relates in general to a system and method for selection of development processes that require corrective action. More particularly, the present invention relates to a system and method for assigning a priority ranking to each improvable development process, and prioritizing the improvable development processes that have a higher priority ranking.

2. Description of the Related Art

The business environment is becoming increasingly competitive. From a consumer standpoint, this results in a quality product at a reasonable price. From a business standpoint, however, a business must continually optimize its processes in order to increase product quality and decrease operating costs.

A business typically incorporates standard processes for each product development stage, such as design, manufacturing, and test. Each product development stage may include processes that range from a best-in-class process, to processes that are so poor, that they jeopardize the success of a particular product line. For example, a process may not detect defects until late in a development cycle, whereby a product defect may result in a business shutting down the product's production line until the cause of the defect is identified. In this example, the business may also decide to issue a product recall in the event that a defective product may have been shipped to customers.

A challenge found, however, is establishing a general consensus from team members as to which development processes to improve. In addition, another challenge found in improving particular processes is the ability to prioritize and allocate resources in order of importance to those processes that require improvement.

What is needed, therefore, is a system and method to objectively identify processes that require continuous improvement, and prioritize those processes in order of importance.

### SUMMARY

It has been discovered that the aforementioned challenges are resolved by using a process improvement-lessons learned procedure to classify and assign priority rankings to improvable development processes. A process improvement lessons-learned procedure includes several stages of list expansions and reductions that consider the probability of poor use of resources, the probability of a process being ineffective that results in poor product quality, and the probability of a process not detecting product defects, thereby causing schedule impacts. The probabilities are multiplied together to provide a list of improvement possibilities for team members to address. In addition, a priority ranking provides the team members with an order in which resources should be applied to each improvable development process.

Team members are selected from different departments, or disciplines, based upon their particular knowledge and skill set in order to participate in the process improvement lessons learned exercise. Each team member provides a list of ideas, in which each of the ideas corresponds to various steps of a development process. Once the ideas are collected, each team member assigns a list reduction classification to each idea. In turn, a majority list reduction classification is assigned to each idea based upon the individual team member's inputs. Ideas that are assigned an “improvable development process” classification proceed through a priority ranking process.

During the priority ranking process, three probability rankings are received from each team member for each improvable development process. First, each team member provides a poor resource use probability ranking for each improvable development process. Second, each team member provides an ineffective process probability ranking for each improvable development process. And third, each team member provides a schedule impact probability ranking for each improvable development process.

Once the three probability rankings are collected for each improvable development process, a priority ranking is calculated for each improvable development process by multiplying each improvable development process' corresponding rankings. The improvable development processes are then sorted using their corresponding priority rankings.

Starting with the improvable development process with the highest priority ranking, an owner is assigned to each improvable development process, and each improvable development process is monitored to ensure that the improvable development process' goals are achieved.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram showing team member using a process improvement lessons learned procedure in order to classify and assign continuous improvement priority rankings to improvable development processes;

FIG. 2A is a list reduction classification table;

FIG. 2B is a poor resource use probability table;

FIG. 3A is an ineffective process probability table;

FIG. 3B is a schedule impact probability table;

FIG. 4 is a high level flow chart showing steps taken in ranking development processes and monitoring the development processes' continuous improvement;

FIG. 5 is a flowchart showing steps taken in selecting team members to rank development processes;

FIG. 6 is a flowchart showing steps taken in classifying team member ideas;

FIG. 7 is a flowchart showing steps taken in collecting a variety of rankings for improvable development processes; and

FIG. 8 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

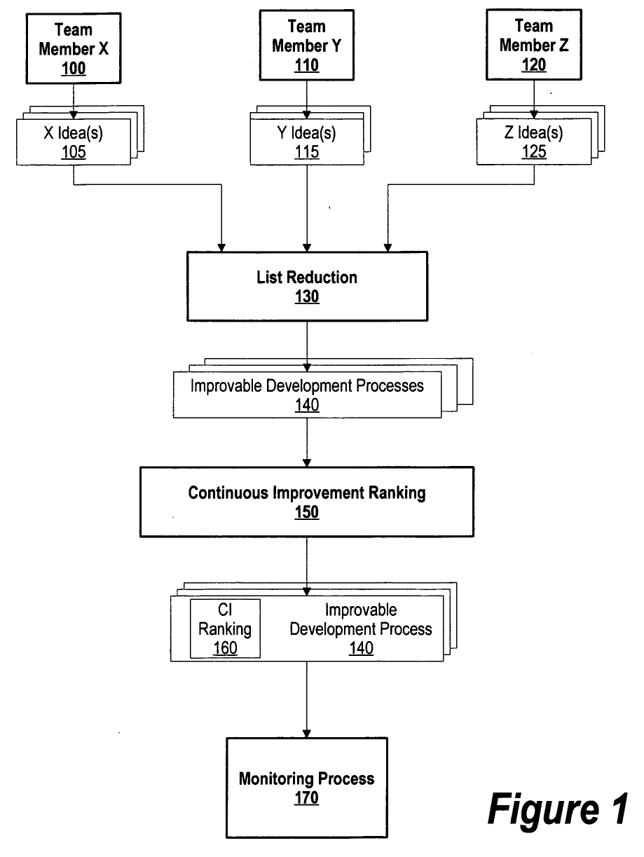

FIG. 1 is a diagram showing team member using a process improvement lessons learned procedure in order to classify and assign continuous improvement priority rankings to improvable development processes. A process improvement lessons learned procedure includes several stages of list expansions and reductions that consider the probability of poor use of resources, the probability of a process being ineffective, and the probability of a process causing schedule impacts. The probabilities are multiplied together to not only provide a list of continuous improvement possibilities a team addresses, but a continuous improvement priority ranking provides a team with the order in which resources should be applied to each improvable development process.

Team member X 100, team member Y 110, and team member Z 120 are from different departments, or disciplines, and have been selected to participate in the process improvement lessons learned exercise based upon their particular knowledge and skill set. Team member X 100 provides X ideas 105, team member Y 110 provides Y ideas 115, and team member Z 120 provides Z ideas 125, in which each of the ideas corresponds to various steps of a development process. Each of the ideas is filtered through list reduction 130 whereby the team members assign a list reduction classification to each idea. Each idea is classified as one of the following:
“D” if the idea is documented as a best of breed process;
“U” if the idea is an undocumented best of breed process;
“N” if the idea is not actually a development process; or
“I” if the idea is an improvable development process.

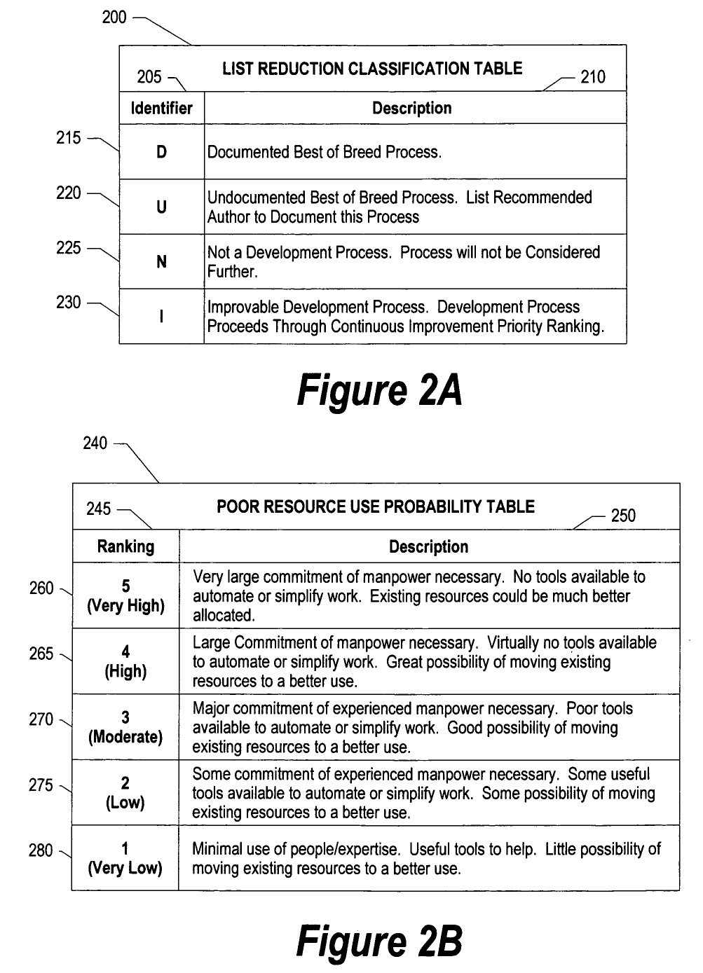

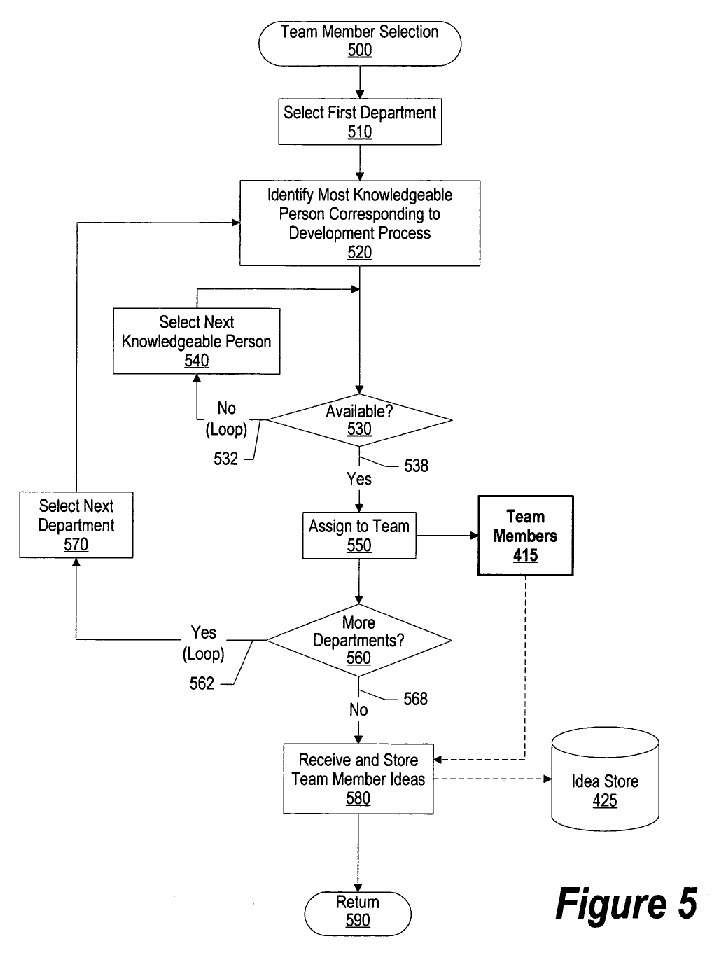

The ideas that are classified “I”, such as improvable development processes 140, are filtered through list reduction 130 and sent to continuous improvement ranking 150 (details of list reduction classification will be provided later in this description and figures, see, e.g., FIGS. 2A, 5, and the description thereto).

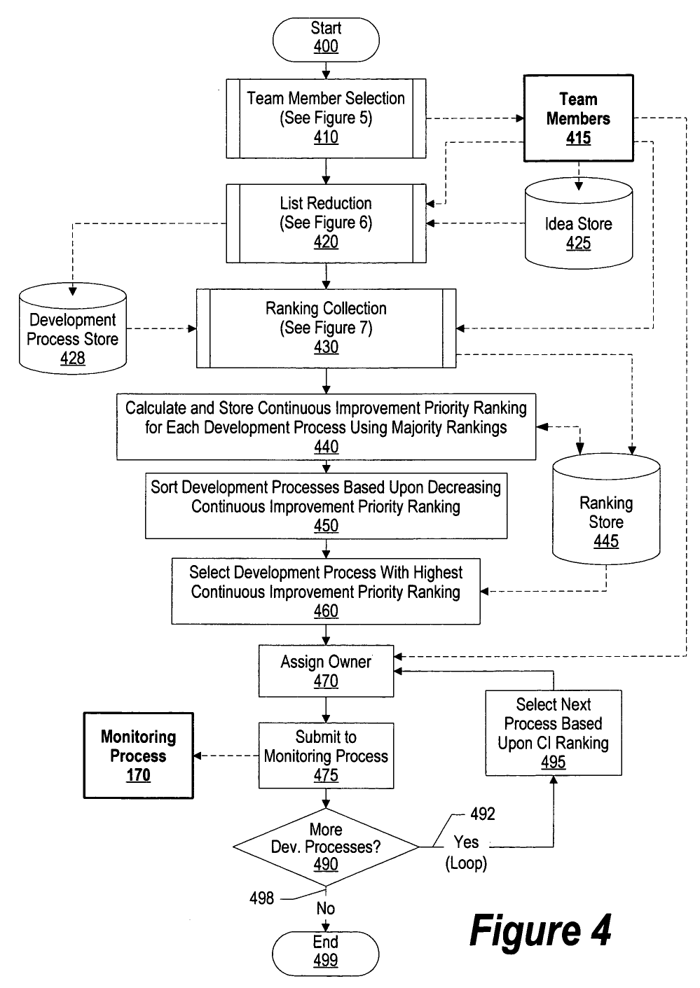

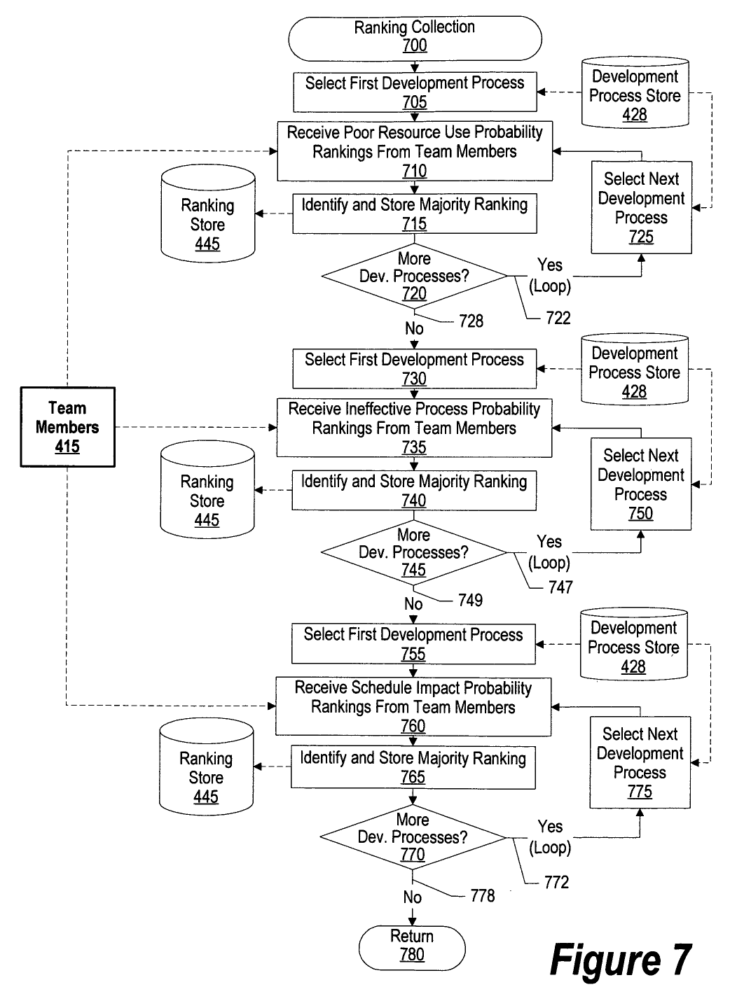

Continuous improvement ranking 150 assigns a plurality of probability rankings to each improvable development process, and computes a priority ranking for each of improvable development processes 140, such as continuous improvement priority ranking 160. Improvable development processes 140 are sorted based upon their corresponding continuous improvement priority rankings 160. Improvable development processes 140 are prioritized and monitored using monitoring process 170 based upon their corresponding continuous improvement priority rankings (i.e. continuous improvement priority rankings 160) (details of probability ranking and continuous improvement prioritization will be provided later in this description and figures, see, e.g., FIGS. 4, 7, and the description thereto). Monitoring process 170 may be a process by which an improvable development process is monitored to ensure that its corresponding goals are achieved.

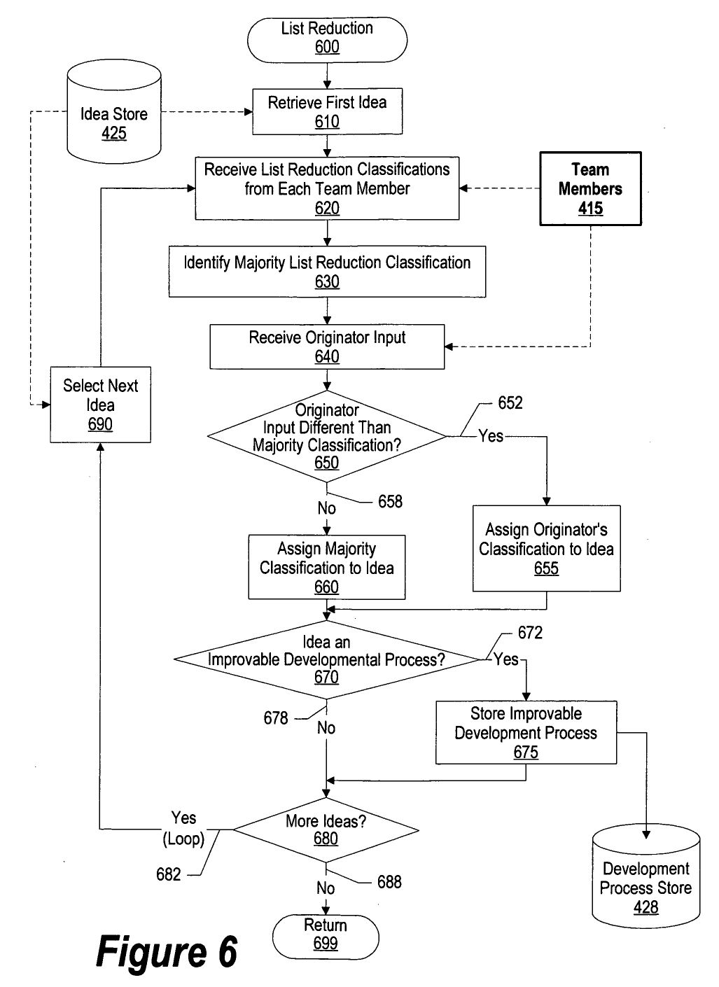

FIG. 2A is a list reduction classification table. Team members use the classifications that are included in table 200 in order to classify particular team member ideas. The ideas correspond to various steps of a development process, and the ideas that are classified as an “improvable development process” proceed through a continuous improvement priority ranking (details of idea classification will be provided later in this description and figures, see, e.g., FIG. 6 and the description thereto).

Table 200 includes columns 205 and 210. Column 205 includes a list of list reduction classifications, whereas column 210 includes a list of descriptions that correspond to the list reduction classifications. Line 215 shows that an idea is classified as “D” if the idea is documented as a best of breed process. Line 220 shows that an idea is classified as “U” if the idea is an undocumented best of breed process. In this situation, the idea's originator may be requested to document the corresponding process. Line 225 shows that an idea that is classified as “N” if the idea is not actually a development process. And, line 235 shows that an idea is classified as “I” if the idea is an improvable development process which, in turn, proceed through a continuous improvement priority ranking process (details of the ranking process will be provided later in this description and figures, see, e.g., FIG. 4, 7, and the description thereto).

FIG. 2B is a poor resource use probability table. Team members use rankings that are included in table 240 in order to rank an improvable development processes based upon how the improvable development process' people and equipment are utilized. Table 240 includes columns 245 and 250. Column 245 includes a list of poor resource use probability rankings and column 250 includes a list of corresponding poor resource use probability ranking descriptions.

Line 260 shows that an improvable development process is ranked “5” when the improvable development process requires a very large manpower commitment, tools are not available to automate or simplify work, or existing resources could be much better allocated. Line 265 shows that an improvable development process is ranked “4” when the improvable development process requires a large manpower commitment, tools are virtually not available to automate or simplify work, or a great possibility exists to move existing resources to better use.

Line 270 shows that an improvable development process is ranked “3” when the improvable development process requires a major commitment of experienced manpower, poor tools are available to automate or simplify work, or a good possibility exists to move existing resources to better use. Line 275 shows that an improvable development process is ranked “2” when the improvable development process requires some commitment of experienced manpower, some useful tools are available to automate or simplify work, or some possibility exists to move existing resources to better use. Line 280 shows that an improvable development process is ranked “1” when the improvable development process requires minimal commitment of experienced manpower, useful tools are available to automate or simplify work, and little possibility exists to move existing resources to better use.

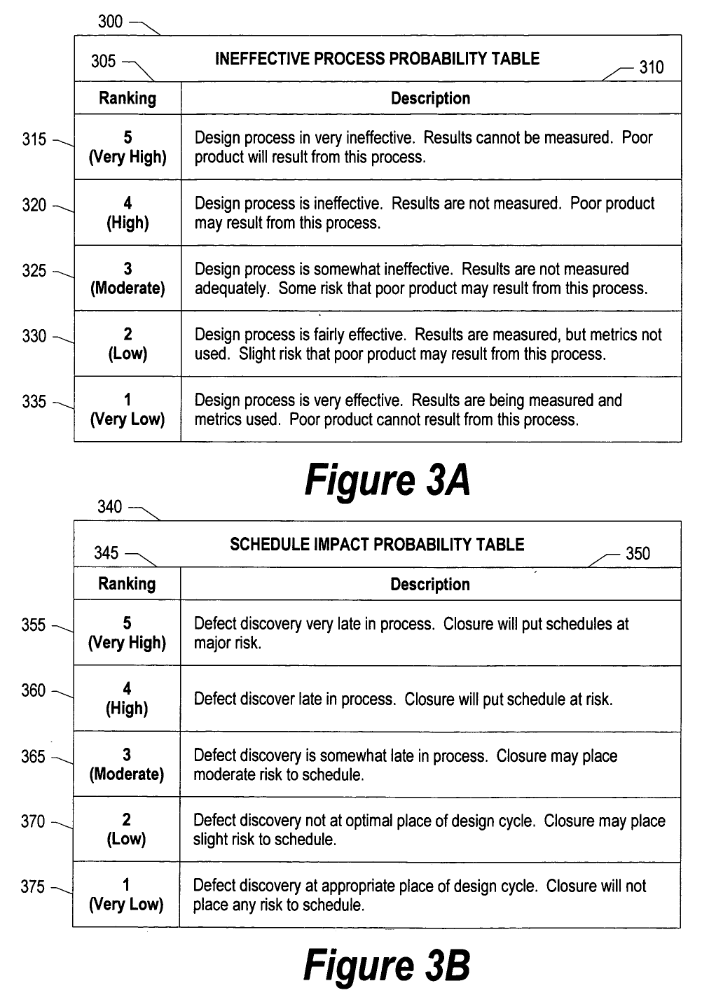

FIG. 3A is an ineffective process probability table. Team members use the rankings that are included in table 300 in order to rank an improvable development process based upon the improvable development process' effectiveness. Table 300 includes columns 305 and 310. Column 305 includes a list of ineffective process probability rankings and column 310 includes a list of corresponding ineffective process probability ranking descriptions.

Line 315 shows that an improvable development process is ranked “5” when the improvable development process is very ineffective, results cannot be measured, or poor product results from the process. Line 320 shows that an improvable development process is ranked “4” if the improvable development process is ineffective, results are not measured, or poor product may result from the process. Line 325 shows that an improvable development process is ranked “3” when the improvable development process is somewhat ineffective, results are not measured adequately, or some risk exists that poor product may result from the process. Line 330 shows that an improvable development process is ranked “2” when the improvable development process is fairly effective, results are measured but metrics are not used, or a slight risk exists that poor product may result from the process. Line 335 shows that an improvable development process is ranked “1” when the improvable development process is very effective, results are measured and metrics are used, and no risk exists that poor product may result from the process.

FIG. 3B is a schedule impact probability table. Team members use the rankings that are included in table 340 in order to rank an improvable development process based upon the improvable development process' defect discovery stage. Table 340 includes columns 345 and 350. Column 345 includes a list of schedule impact probability rankings and column 350 includes a list of corresponding schedule impact probability ranking descriptions.

Line 355 shows that an improvable development process is ranked “5” when the improvable development process' defect discovery is very late in the process and closure places schedules at major risk. Line 360 shows that an improvable development process is ranked “4” when the improvable development process' defect discovery is late in the process and closure places schedules at risk. Line 365 shows that an improvable development process is ranked “3” when the improvable development process' defect discovery is somewhat late in the process and closure may place schedules at moderate risk. Line 370 shows that an improvable development process is ranked “2” when the improvable development process' defect discovery is not at an optimal place of a design cycle and closure may place schedules at a slight risk. Line 375 shows that an improvable development process is ranked “1” when the improvable development process' defect discovery is at an appropriate place of a design cycle and closure does not place the schedule at risk.

FIG. 4 is a high level flow chart showing steps taken in ranking development processes and monitoring the development processes' continuous improvement. Processing commences at 400, whereupon processing selects team members, such as team members 415, from a variety of disciplines that participate in ranking the development processes. Processing then receives a list of ideas from team members 415 which correspond to various steps of a development process, and stores the ideas in idea store 425 (pre-defined process block 410, see FIG. 5 and corresponding text for further details). Idea store 425 may be stored on a nonvolatile storage area, such as a computer hard drive.

Once the team member ideas are collected, processing receives list reduction classifications for each idea from each team member, and stores the ideas in development process store 428 that are classified as an “improvable development process” (pre-defined process block 420, see FIG. 2A and corresponding text for further details). Development process store 428 may be stored on a nonvolatile storage area, such as a computer hard drive.

Processing receives a variety of development process rankings from team members 415 for each of the improvable development processes, whereby the variety of rankings may include a poor resource use probability ranking, an ineffective process probability ranking, and a schedule impact probability ranking (pre-defined process block 430, see FIG. 7 and corresponding text for further details).

At step 440, processing calculates a continuous improvement priority ranking for each improvable development process, and stores the continuous improvement priority rankings in ranking store 445. A continuous improvement priority ranking is calculated using the poor resource use probability ranking (PRUP), the ineffective process probability ranking (IPPR), and the schedule impact probability ranking (SIPR) as follows:
CI Priority Ranking=PRUP*IPPR*SIPR

The higher an improvable development process' continuous improvement priority ranking, the more emphasis is placed on the improvable development process for continuous improvement. At step 450, processing sorts each improvable development process using its corresponding continuous improvement priority ranking. For example, if a continuous improvement priority ranking of “125” is the highest continuous improvement priority ranking an improvable development process may receive, then the improvable development processes that have a continuous improvement priority ranking of 125 are at the top of the sorted list. Once the improvable development processes are sorted, processing selects the first improvable development process with the highest continuous improvement priority ranking at step 460.

Processing receives an owner assignment from team members 415 to correspond to the selected improvable development process at step 470. At step 475, processing submits the improvable development process to monitoring process 170. Monitoring process 170 is the same as that shown in FIG. 1, and may be a process by which an improvable development process is monitored to ensure that its continuous improvement goals are achieved.

A determination is made as to whether there are more improvable development processes to assign an owner and submit to monitoring process 170 (decision 490). If there are more improvable development processes, decision 490 branches to “Yes” branch 492 which loops back to select (step 495) and process the next improvable development process. This looping continues until there are no more improvable development processes to assign an owner and submit to monitoring process 480, at which point decision 490 branches to “No” branch 498 whereupon processing ends at 499.

FIG. 5 is a flowchart showing steps taken in selecting team members to rank development processes. Processing commences at 500, whereupon a first department that corresponds to a particular discipline is selected, such as “manufacturing” (step 510). At step 520, processing identifies the most knowledgeable person in the selected department that understands development processes and is able to provide meaningful input towards ranking improvable development processes.

A determination is made as to whether the identified person is available (decision 530). For example, processing may access a company's calendar system in order to determine whether the identified person is available to participate in an improvable development process ranking exercise. In one embodiment, in order to allow a most knowledgeable person to be a team member when he has conflicting schedules, the team member may submit his improvable development process rankings prior to the improvable development process ranking exercise.

If the most knowledgeable person is not available, decision 530 branches to “No” branch 532 which loops back to select (step 540) the next knowledgeable person and determine whether the person is available. This looping continues until a knowledgeable person is available, at which point decision 530 branches to “Yes” branch 538 whereupon processing assigns the available person to team members 415 (step 550). Team members 415 are the same as that shown in FIG. 4.

A determination is made as to whether there are more relevant departments from which to assign a team member (decision 560). If there are more departments from which to assign a team member, decision 560 branches to “Yes” branch 562 which loops back to select (step 570) and process the next department. This looping continues until a team member is selected from each relevant department, whereupon decision 560 branches to “No” branch 568.

At step 580, processing receives ides from team members 415 and stores the ideas in idea store 425. The team members' ideas correspond to various steps of a development process. Processing returns at 590.

FIG. 6 is a flowchart showing steps taken in classifying team member ideas. Processing commences at 600, whereupon processing retrieves a first idea from idea store 425 at step 510. Ideas were collected from team members whereby the ideas correspond to various steps of a development process (details of idea collection are provided in other areas of this description and figures, see, e.g., FIG. 5 and the description thereto). At step 620, processing receives a list reduction classification from each team member that is part of team members 415. A list reduction classification may be “D” for a documented best of breed process, “U” for an undocumented best of breed processes, “N” if the idea is not a development process, or “I” if the idea is an improvable development process (details of list reduction classification properties are provided in other areas of this description and figures, see, e.g., FIG. 2A and the description thereto). Team members 415 are the same as that shown in FIG. 4.

At step 630, processing identifies a majority list reduction classification corresponding to the first idea. For example, if processing receives five I's, three N's, and two D's, then processing identifies “I” as the majority list reduction classification. As one skilled in the art can appreciate, other classification methods, such as a numbering system, may be used to classify the ideas.

Processing identifies an originator in team members 415 corresponding to the first idea at step 640, and identifies the originator's list reduction classification. Processing identifies the originator's list reduction classification in order to determine whether it is different than the majority list reduction classification, and, if so, allows the originator to explain his classification reasoning.

A determination is made as to whether the originator's list reduction classification is different than the majority list reduction classification (decision 650). If it is different, decision 650 branches to “Yes” branch 652 whereupon processing assigns the originator's list reduction classification to the particular idea (step 655). In one embodiment, processing overrides the majority list reduction classification with the originator's list reduction classification if the originator provides a compelling argument as to why to override the majority list reduction classification.

On the other hand, if the originator's list reduction classification is the same as the majority list reduction classification, decision 650 branches to “No” branch 658 whereupon processing assigns the majority list reduction classification to the particular idea at step 660.

A determination is made as to whether the particular idea's list reduction classification is an “improvable development process” (decision 670). If the particular idea's list reduction classification is an improvable development process, decision 670 branches to “Yes” branch 672 whereupon processing stores the improvable development process in development process store 428 for future continuous improvement priority ranking steps (step 675). On the other hand, if the particular idea is not classified as an improvable development process, decision 670 branches to “No” branch 678 bypassing development process storage steps. For example, if an idea is already a documented best of breed process, there is not a requirement to further improve the process (details of list reduction classification are provided in other areas of this description and figures, see, e.g., FIG. 2A and the description thereto).

A determination is made as to whether there are more ideas to assign a list reduction classification (decision 680). If there are more ideas to assign a list reduction classification, decision 680 branches to “Yes” branch 682 which loops back to select (step 690) and process the next idea. This looping continues until there are no more ideas to process, at which point decision 680 branches to “No” branch 688 whereupon processing returns at 699.

FIG. 7 is a flowchart showing steps taken in collecting a variety of rankings for improvable development processes. Team member ideas are classified, and those ideas that are classified as an “improvable development process” proceed through the ranking process (details of idea classification are provided in other areas of this description and figures, see, e.g., FIG. 6 and the description thereto).

Processing commences at 700, whereupon processing selects a first improvable development process from development process store 428 at step 705. Development process store 428 is the same as that shown in FIG. 4 and may be stored on a nonvolatile storage area, such as a computer hard drive.

At step 710, processing receives a “poor resource use probability ranking” from each team member that is part of team members 415. A poor resource use probability ranking corresponds to how well the resources (e.g. people, equipment, etc.) are utilized for a particular improvable development process. The poor resource use probability ranking may range from “1-5” whereby “1” corresponds to the resources being utilized well and “5” corresponds to the resources not being utilized well (details of poor resource use probability rankings are provided in other areas of this description and figures, see, e.g., FIG. 2B the description thereto). At step 715, processing identifies a majority poor resource use probability ranking and stores it in ranking store 445. For example, processing may use each team member's ranking in order to calculate an average ranking.

A determination is made as to whether there are more improvable development processes to receive poor resource use probability rankings (decision 720). If there are more improvable development processes to receive poor resource use probability rankings, decision 720 branches to “Yes” branch 722 which loops back to select (step 725) and process the next improvable development process. This looping continues until there are no more improvable development processes to receive poor resource use probability rankings, at which point decision 720 branches to “No” branch 728.

Once a majority poor resource probability ranking is assigned to each improvable development process, processing begins its next ranking by once again selecting the first improvable development process from development process store 428 at step 730. At step 735, processing receives an “ineffective process probability ranking” from each team member. An ineffective process probability ranking corresponds to a particular improvable development process' ineffectiveness. The ineffective probability ranking may range from 1-5 whereby 1 corresponds to an improvable development process being very effective and 5 corresponds to an improvable development process being very ineffective (details of ineffective process probability ranking are provided in other areas of this description and figures, see, e.g., FIG. 3A and the description thereto). At step 740, processing identifies a majority ineffective process probability ranking and stores it in ranking store 445. For example, processing may use each team member's ranking in order to calculate an average ranking.

A determination is made as to whether there are more improvable development processes to receive ineffective process probability rankings (decision 745). If there are more improvable development processes to receive ineffective process probability rankings, decision 745 branches to “Yes” branch 747 which loops back to select (step 750) and process the next improvable development process. This looping continues until there are no more improvable development processes to receive ineffective process probability rankings, at which point decision 745 branches to “No” branch 749.

Once a majority ineffective process probability ranking is assigned to each improvable development process, processing begins its next ranking by once again selecting the first improvable development process from development process store 428 at step 755. At step 760, processing receives a “schedule impact probability ranking” from each team member. A schedule impact probability ranking corresponds to an improvable development process' stage location that defects are discovered and closed. The schedule impact ranking may range from 1-5 whereby 1 corresponds to defects being discovered at an appropriate stage and 5 corresponds to defects being discovered at a very late stage in the process (details of schedule impact probability rankings are provided in other areas of this description and figures, see, e.g., FIG. 3B and the description thereto). At step 765, processing identifies a majority schedule impact probability ranking and stores it in ranking store 445. For example, processing may use each team member's ranking in order to calculate an average ranking.

A determination is made as to whether there are more improvable development processes to receive schedule impact probability rankings (decision 770). If there are more improvable development processes to receive schedule impact probability rankings, decision 770 branches to “Yes” branch 772 which loops back to select (step 775) and process the next improvable development process. This looping continues until there are no more improvable development processes to receive schedule impact probability rankings, at which point decision 770 branches to “No” branch 778 whereupon processing returns at 780.

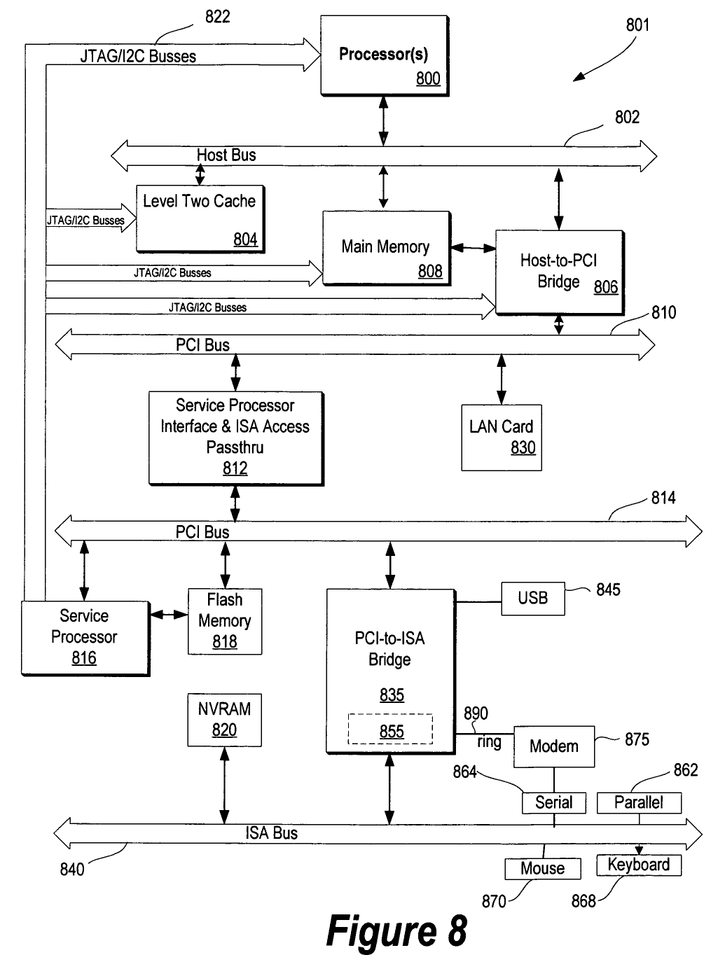

FIG. 8 illustrates information handling system 801 which is a simplified example of a computer system capable of performing the computing operations described herein. Computer system 801 includes processor 800 which is coupled to host bus 802. A level two (L2) cache memory 804 is also coupled to host bus 802. Host-to-PCI bridge 806 is coupled to main memory 808, includes cache memory and main memory control functions, and provides bus control to handle transfers among PCI bus 810, processor 800, L2 cache 804, main memory 808, and host bus 802. Main memory 808 is coupled to Host-to-PCI bridge 806 as well as host bus 802. Devices used solely by host processor(s) 800, such as LAN card 830, are coupled to PCI bus 810. Service Processor Interface and ISA Access Pass-through 812 provides an interface between PCI bus 810 and PCI bus 814. In this manner, PCI bus 814 is insulated from PCI bus 810. Devices, such as flash memory 818, are coupled to PCI bus 814. In one implementation, flash memory 818 includes BIOS code that incorporates the necessary processor executable code for a variety of low-level system functions and system boot functions.

PCI bus 814 provides an interface for a variety of devices that are shared by host processor(s) 800 and Service Processor 816 including, for example, flash memory 818. PCI-to-ISA bridge 835 provides bus control to handle transfers between PCI bus 814 and ISA bus 840, universal serial bus (USB) functionality 845, power management functionality 855, and can include other functional elements not shown, such as a real-time clock (RTC), DMA control, interrupt support, and system management bus support. Nonvolatile RAM 820 is attached to ISA Bus 840. Service Processor 816 includes JTAG and I2C busses 822 for communication with processor(s) 800 during initialization steps. JTAG/I2C busses 822 are also coupled to L2 cache 804, Host-to-PCI bridge 806, and main memory 808 providing a communications path between the processor, the Service Processor, the L2 cache, the Host-to-PCI bridge, and the main memory. Service Processor 816 also has access to system power resources for powering down information handling device 801.

Peripheral devices and input/output (I/O) devices can be attached to various interfaces (e.g., parallel interface 862, serial interface 864, keyboard interface 868, and mouse interface 870 coupled to ISA bus 840. Alternatively, many I/O devices can be accommodated by a super I/O controller (not shown) attached to ISA bus 840.

In order to attach computer system 801 to another computer system to copy files over a network, LAN card 830 is coupled to PCI bus 810. Similarly, to connect computer system 801 to an ISP to connect to the Internet using a telephone line connection, modem 875 is connected to serial port 864 and PCI-to-ISA Bridge 835.

While the computer system described in FIG. 8 is capable of executing the processes described herein, this computer system is simply one example of a computer system. Those skilled in the art will appreciate that many other computer system designs are capable of performing the processes described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A computer-implemented method comprising:
identifying a plurality of improvable development processes;
applying a plurality of rankings to each of the plurality of improvable development processes;
calculating a priority ranking for each of the plurality of improvable development processes using each of the improvable design processes' corresponding plurality of rankings; and
prioritizing the plurality of improvable development processes based upon each of the plurality of improvable development processes' priority rankings.

2. The method of claim 1 wherein the identifying further comprises:
receiving an idea;
receiving a plurality of list reduction classifications from a plurality of team members;
computing a majority list reduction classification based upon the plurality of list reduction classifications; and
determining whether the idea is an improvable development process based upon the majority list reduction classification.

3. The method of claim 2 further comprising:
identifying an originator list reduction classification;
determining whether the originator list reduction classification is different than the majority list reduction classification; and
overriding the majority list reduction classification with the originator list reduction classification based upon the determination.

4. The method of claim 1 wherein at least one of the plurality of rankings is selected from the group consisting of a poor resource use probability ranking, an ineffective process probability ranking, and a schedule impact probability ranking.

5. The method of claim 1 further comprising:
selecting a highest priority improvable development process based upon the prioritizing;
assigning an owner to the highest priority improvable development process; and
sending monitoring updates to the owner, wherein the monitoring updates correspond to the progress of the improvable development process.

6. The method of claim 1 wherein the plurality of rankings are received from a plurality of team members.

7. The method of claim 1 wherein the calculating further comprises:
multiplying the plurality of rankings for one of the plurality of improvable development processes, the multiplying resulting in the priority ranking.

8. A program product comprising:
computer operable medium having computer program code, the computer program code being effective to:
identify a plurality of improvable development processes;
apply a plurality of rankings to each of the plurality of improvable development processes;
calculate a priority ranking for each of the plurality of improvable development processes using each of the improvable design processes' corresponding plurality of rankings; and
prioritize the plurality of improvable development processes based upon each of the plurality of improvable development processes' priority rankings.

9. The program product of claim 8 wherein the computer program code is further effective to:
receive an idea;
receive a plurality of list reduction classifications from a plurality of team members;
compute a majority list reduction classification based upon the plurality of list reduction classifications; and
determine whether the idea is an improvable development process based upon the majority list reduction classification.

10. The program product of claim 9 wherein the computer program code is further effective to:
identify an originator list reduction classification;
determine whether the originator list reduction classification is different than the majority list reduction classification; and
override the majority list reduction classification with the originator list reduction classification based upon the determination.

11. The program product of claim 8 wherein at least one of the plurality of rankings is selected from the group consisting of a poor resource use probability ranking, an ineffective process probability ranking, and a schedule impact probability ranking.

12. The program product of claim 8 wherein the computer program code is further effective to:
select a highest priority improvable development process based upon the prioritizing;
assign an owner to the highest priority improvable development process; and
send monitoring updates to the owner, wherein the monitoring updates correspond to the progress of the improvable development process.

13. The program product of claim 8 wherein the plurality of rankings are received from a plurality of team members.

14. The program product of claim 8 wherein the computer program code is further effective to:
multiply the plurality of rankings for one of the plurality of improvable development processes, the multiplying resulting in the priority ranking.

15. An information handling system comprising:
one or more processors;
a memory accessible by the processors;
one or more nonvolatile storage devices accessible by the processors; and
a development process tool for identifying and prioritizing improvable development processes, the development process tool comprising software code effective to:
identify a plurality of improvable development processes that are located in one of the nonvolatile storage devices;
apply a plurality of rankings to each of the plurality of improvable development processes, the plurality of rankings being located in one of the nonvolatile storage devices;
calculate a priority ranking for each of the plurality of improvable development processes using each of the improvable design processes' corresponding plurality of rankings;
prioritize the plurality of improvable development processes based upon each of the plurality of improvable development processes' priority rankings; and
store the prioritized plurality of improvable development processes in one of the nonvolatile storage devices.

16. The information handling system of claim 15 wherein the software code is further effective to:
receive an idea over a computer network;
receive a plurality of list reduction classifications from a plurality of team members over the computer network;
compute a majority list reduction classification based upon the plurality of list reduction classifications; and
determine whether the idea is an improvable development process based upon the majority list reduction classification.

17. The information handling system of claim 16 wherein the software code is further effective to:
identify an originator list reduction classification that is located in one of the nonvolatile storage devices;
determine whether the originator list reduction classification is different than the majority list reduction classification; and
override the majority list reduction classification with the originator list reduction classification based upon the determination.

18. The information handling system of claim 15 wherein at least one of the plurality of rankings is selected from the group consisting of a poor resource use probability ranking, an ineffective process probability ranking, and a schedule impact probability ranking.

19. The information handling system of claim 15 wherein the software code is further effective to:
select a highest priority improvable development process based upon the prioritizing;
assign an owner identifier to the highest priority improvable development process; and
send monitoring updates to the owner that corresponds to the owner identifier over a computer network, wherein the monitoring updates correspond to the progress of the improvable development process.

20. The information handling system of claim 15 wherein the plurality of rankings are received from a plurality of team members.

21. The information handling system of claim 15 wherein the software code is further effective to:
multiply the plurality of rankings for one of the plurality of improvable development processes, the multiplying resulting in the priority ranking.

22. A computer-implemented method comprising:
receiving a plurality of ideas;
receiving a plurality of list reduction classifications from a plurality of team members;
computing a majority list reduction classification for each of the plurality of ideas based upon the plurality of list reduction classifications;
identifying a plurality of improvable development processes based upon the plurality of majority list reduction classifications;
applying a plurality of rankings to the plurality of improvable development processes;
calculating a priority ranking for each of the plurality of improvable development processes using each of the improvable design processes' corresponding plurality of rankings; and
prioritizing the plurality of improvable development processes based upon each of the plurality of improvable development processes' priority rankings.

23. A computer-implemented method comprising:
identifying a plurality of improvable development processes;
applying a plurality of rankings to each of the plurality of improvable development processes, wherein at least one of the plurality of rankings is selected from the group consisting of a poor resource use probability ranking, an ineffective process probability ranking, and a schedule impact probability ranking;
calculating a priority ranking for each of the plurality of improvable development processes using each of the improvable design processes' corresponding plurality of rankings; and
prioritizing the plurality of improvable development processes based upon each of the plurality of improvable development processes' priority rankings.

24. A program product comprising:
computer operable medium having computer program code, the computer program code being effective to:
receive a plurality of ideas;
receive a plurality of list reduction classifications from a plurality of team members;
computing a majority list reduction classification for each of the plurality of ideas based upon the plurality of list reduction classifications;
identify a plurality of improvable development processes based upon the plurality of majority list reduction classifications;
apply a plurality of rankings to the plurality of improvable development processes;
calculate a priority ranking for each of the plurality of improvable development processes using each of the improvable design processes' corresponding plurality of rankings; and
prioritize the plurality of improvable development processes based upon each of the plurality of improvable development processes' priority rankings.

25. A program product comprising:
computer operable medium having computer program code, the computer program code being effective to:
identify a plurality of improvable development processes;
apply a plurality of rankings to each of the plurality of improvable development processes, wherein at least one of the plurality of rankings is selected from the group consisting of a poor resource use probability ranking, an ineffective process probability ranking, and a schedule impact probability ranking;
calculate a priority ranking for each of the plurality of improvable development processes using each of the improvable design processes' corresponding plurality of rankings; and
prioritize the plurality of improvable development processes based upon each of the plurality of improvable development processes' priority rankings.

26. An information handling system comprising:
one or more processors;
a memory accessible by the processors;
one or more nonvolatile storage devices accessible by the processors; and
a development process tool for identifying and prioritizing improvable development processes, the development process tool comprising software code effective to:
receive a plurality of ideas over a computer network;
receive a plurality of list reduction classifications from a plurality of team members over the computer network;
computing a majority list reduction classification for each of the plurality of ideas based upon the plurality of list reduction classifications;
identify a plurality of improvable development processes based upon the plurality of majority list reduction classifications;
apply a plurality of rankings to the plurality of improvable development processes, the plurality of rankings being located in one of the nonvolatile storage devices;
calculate a priority ranking for each of the plurality of improvable development processes using each of the improvable design processes' corresponding plurality of rankings;
prioritize the plurality of improvable development processes based upon each of the plurality of improvable development processes' priority rankings; and
store the prioritized plurality of improvable development processes in one of the nonvolatile storage devices.
